(19) United States
(12) Patent Application Publication
(10) Pub. No.: US 2013/0318808 A1
(43) Pub. Date: Dec. 5, 2013

(54) Marker Tags for Positioning Objects

(71) Applicants: Claudia Howe, Scottsdale, AZ (US); Wendy Kuhn, Flagstaff, AZ (US)

(72) Inventors: Claudia Howe, Scottsdale, AZ (US); Wendy Kuhn, Flagstaff, AZ (US)

(21) Appl. No.: 13/483,246

(22) Filed: May 30, 2012

(51) Int. Cl. B25H 7/04

(52) U.S. Cl. 33/666

(57) ABSTRACT

In various representative aspects, apparatus and system for an elongated marker tag that generally comprises a front side, a rear side, and a positioning aid. The front side and the rear side are at least partially comprised of adhesive areas. The adhesive area on the first side substantially covers the top. The adhesive area on the back is at or near the bottom and preferably at least ½ inch away from the top to leave room for the user to press the tag.

### BACKGROUND OF INVENTION

The present invention relates generally to marker tags for positioning an object on a surface. Such an object can be a frame, picture, wall hanging, clock, and so forth. The surface can be a wall, floor, and any surface to mount an object on. More specifically, the invention relates to an apparatus and a system for providing adhesive marker tags having positioning aids to assist users in placing fasteners in order to mount objects on surfaces.

Positioning and fastening an object is often difficult to any degree of accuracy, especially for a single user. Often installers use trial and error methods of placement or a second operator to aid in the placement of an object. Known positioning markers are difficult to use and generally cannot provide satisfactory accuracy.

Some solutions seek to mark the target location with a chalk or by making an indent on the surface. For example, US patent U.S. Pat. No. 6,574,880 (Lombardo) discloses a marker, e.g. a chalk, with a pointed tip and an adhesive surface to adhere to the object to be mounted on the surface. To use Lombardo's marker, however, the user has to press the object against the surface and make sure that the pointed tip contacts the surface and leaves a mark. Another example is US patent U.S. Pat. No. 4,382,337 (Bendick), which teaches a marking pointer suspended by a rope and having a groove to receive the cord of the object to be hung on the wall. In addition to the same issue with Lombardo's marker, this device is suitable only for objects with a cord.

Other solutions mark the target location by transferring a marker from the object to the surface. For example, two US patents, U.S. Pat. Nos. 7,185,442 and 7,350,312 (collectively, “Grillo”), teach a marker with a target indicia on a target patch which has two adhesive sides. The patch is temporarily attached to the rear side of the object and transfers to the wall after the object is pressed against the wall. Again, the user cannot be sure whether the patch has successfully transferred to the wall until the object is removed. If the patch is still attached to the object, the user would have to repeat the process again. This problem would be more obvious when the surface is uneven.

### SUMMARY OF THE INVENTION

The invention is summarized below only for purposes of introducing embodiments of the invention. The ultimate scope of the invention is to be limited only to the claims that follow the specification.

It is an object of this invention to provide a marking device, apparatus, and system for a single user to easily determine where the fastener should be placed on a surface in order to mount an object on the surface. Broadly speaking, the present invention improves marker tags used to position an object to be mounted on a surface by adopting an elongated configuration. A portion of the elongated marker tag sticks out when the tag is attached to the rear side of the object so that the user can see the tag while placing the object at a desired location on the surface. To ensure the tag adheres to the surface, the user may press the tag before or at the time of removing the object.

An embodiment of this invention comprises at least a paper tag in the shape of a strip with adhesive applied on a portion of the front side and the rear side, with the front side facing the surface and the rear side facing the rear of the object when placing the object against the surface. The adhesive area of the front side is generally at the top of the tag while the adhesive area of the rear side is near the bottom. The adhesive area of the rear side is generally below the adhesive area of the front side (farther away from the tag's top peripheral), and preferably they do not overlap. A through-hole, working as a positioning aid, can be located at the bottom of the tag. This embodiment may also have an indication on the rear side, near the top of the tag, showing the user where to press the tag.

An alternate embodiment of this invention might include a single backing sheet and multiple elongated marker tags as aforementioned. The backing sheet is preferably larger than a tag so that at least one tag can be affixed to it. Other tags are stacked one on another. This embodiment may also include at least one cover sheet to be attached to the tag(s) on the top of the stacked tags.

A person with ordinary skills in the relevant art would know that a marker tag can be made of any suitable materials and into any shape as long as it can stick out from the perimeter of the object. The adhesive used in this invention can be any adhesive suitable to temporarily affix the tag to the object and the surface. The backing sheet can be of any material suitable for adhering to the tag(s). A positioning aid can also be any target indicia other than a through-hole, such as a bull's-eye mark printed on the tag or a combination of a hole and a mark. Moreover, the positioning aid can be located anywhere but preferably at or near the adhesive area of the back side and visible from both sides.

### BRIEF DESCRIPTION OF THE DRAWINGS

A more complete understanding of the present invention may be derived by referring to the detailed description and claims when considered in connection with the following illustrative figures. In the following figures, like reference numbers refer to similar elements and steps throughout the figures.

FIG. 1 shows a perspective front view of the elongated marker tag of the preferred embodiment.

FIG. 2 illustrates the rear side of the tag of the preferred embodiment shown in FIG. 1.

FIG. 3 illustrates an embodiment of this invention which comprises a backing sheet with multiple elongated marker tags.

FIGS. 4a-f illustrate how a user may use the tag of the embodiment for positioning a frame on the wall.

### DETAILED DESCRIPTION OF EXEMPLARY EMBODIMENTS

In the following description, and for the purposes of explanation, numerous specific details are set forth in order to provide a thorough understanding of the various aspects of the invention. It will be understood, however, by those skilled in the relevant arts, that the present invention may be practiced without these specific details. In other instances, known structures and devices are shown or discussed more generally in order to avoid obscuring the invention. In many cases, a description of the operation is sufficient to enable one to implement the various forms of the invention, particularly when the operation is to be implemented in software. It should be noted that there are many different and alternative configurations, devices and technologies to which the disclosed inventions may be applied. The full scope of the inventions is not limited to the examples that are described below.

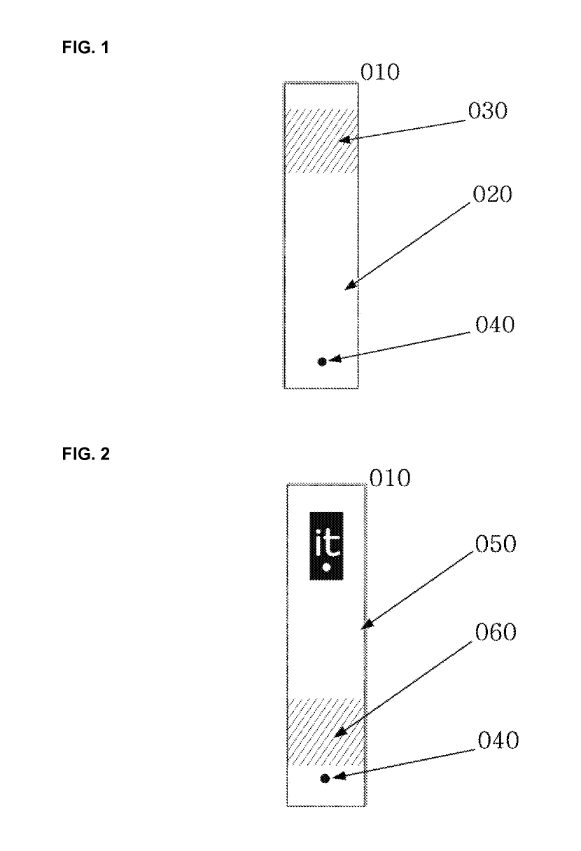

FIG. 1 illustrates the preferred embodiment of this invention. The elongated marker tag 010 has a front side 020 which contains an adhesive area 030 at the top end and a positioning aid 040, a through-hole that is visible from both sides of the tag.

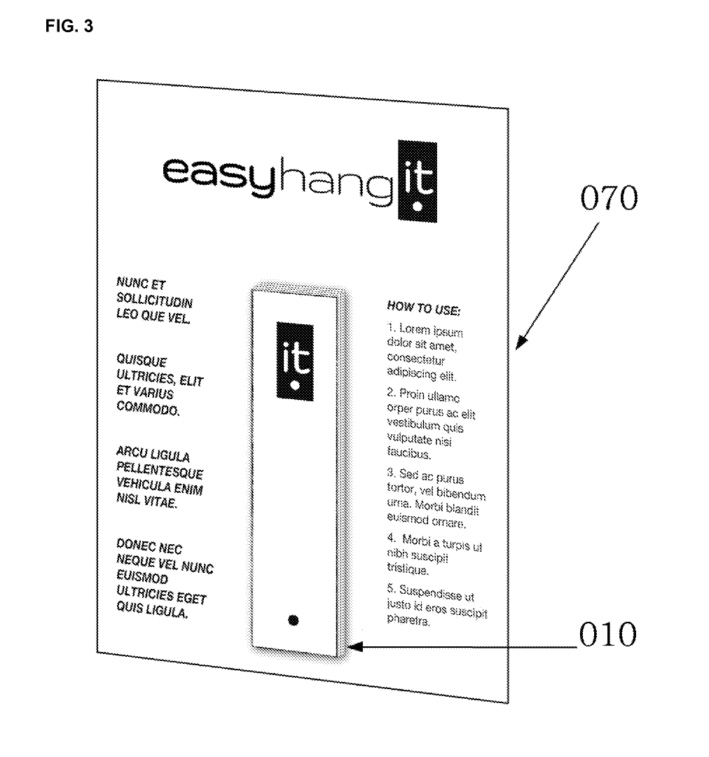

FIG. 2 illustrates the rear side 050 of the tag 010. The adhesive area 060 of the rear side 050 is located near the bottom, at least ½ inch away from the top, and is close to the positioning aid 040.

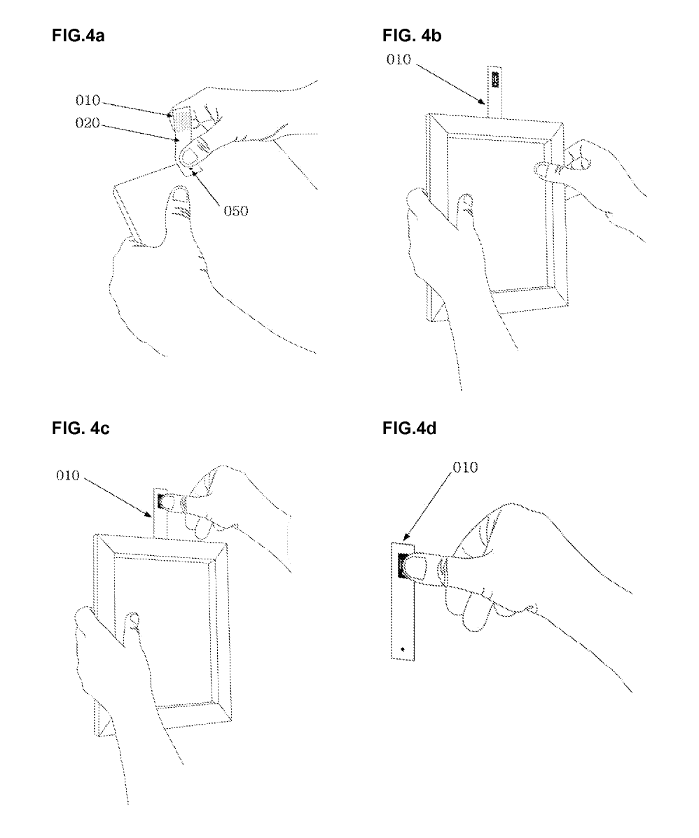

FIG. 3 illustrates an alternate embodiment of this invention with a single backing sheet 070 and more than one tags 010. One tag is temporarily adhered to the backing sheet 070 and each of the tags 010 attaches to one another. A side of the backing sheet 070 has printed instructions for use.

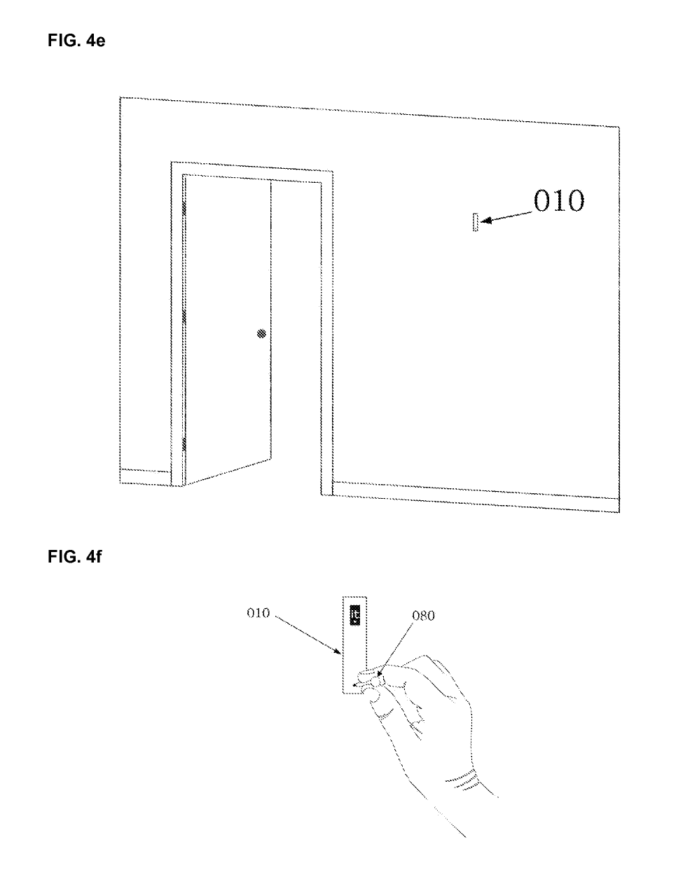

FIGS. 4a-f illustrate how a user may use a tag 010 to hang a frame on a wall. FIG. 4a shows the user adheres the tag 010 on the rear of the frame with the positioning aid 050 aligned to where the fastener will be coupled with the frame. The side facing the user now is the front side 020. FIG. 4b illustrates the user holding and positioning the frame on the wall. Once the location is decided, the user in FIG. 4c presses the top of the tag 010 to ensure that the tag adheres to the wall. FIG. 4d shows the user pressing the tag against the wall when removing the object. FIG. 4e illustrate the tag 010 affixed on the wall after the frame is removed. A hanger 080, as shown in FIG. 4f, is being placed on the wall through the positioning aid.

What is claimed is:

1. An elongated marker tag for positioning an object onto a surface, comprising:
a first side of the tag with a first adhesive area, the first adhesive area located on a top portion of the tag;
a second side of the tag with a second adhesive area, the second adhesive area located on a bottom portion of the tag; and
a positioning aid located on the bottom portion of the tag, wherein a distance between a top of the second adhesive area and a top peripheral of the tag is equal to or greater than a distance between a bottom of the first adhesive area and the top peripheral of the tag.

2. The elongated marker tag of claim 1, wherein the first adhesive area has a first adhesion stronger than a second adhesion of the second adhesive area.

3. The elongated marker tag of claim 1, wherein the first adhesive area has a first surface area bigger than a second surface area of the second adhesive area.

4. The elongated marker tag of claim 1, wherein the positioning aid comprises a hole.

5. The elongated marker tag of claim 1, wherein the tag further comprises an indication located on the top portion of the tag.

6. A marking system for positioning an object onto a surface, comprising:
a single backing sheet;
an elongated marker tag having a first side with a first adhesive area, the first adhesive area located on a top portion of the tag, a second side of the tag with a second adhesive area, the second adhesive area located on a bottom portion of the tag, and a positioning aid located on the bottom portion of the tag, wherein
the tag is affixed to the single backing sheet, and a distance between a top of the second adhesive area and a top peripheral of the tag is equal to or greater than a distance between a bottom of the first adhesive area and the top peripheral of the tag.

7. The marking system of claim 6, wherein the single backing sheet has a side suitable for printing.

8. The marking system of claim 6, wherein the single backing sheet has a first material that is stiffer than a second material of the tag.

9. The marking system of claim 6, wherein the marking system further comprises
a first elongated marker tag and a second elongated marker tag,
the first tag is affixed to the single backing sheet, and
the second tag is affixed to the first tag.

10. The marking system of claim 9, wherein the marking system further comprises a cover sheet that is affixed to the second tag.

11. The marking system of claim 6, wherein the first adhesive area has a first adhesion stronger than a second adhesion of the second adhesive.

12. The marking system of claim 6, wherein the first adhesive area has a first surface area bigger than a second surface area of the second adhesive area.

13. The marking system of claim 6, wherein the positioning aid comprises a hole.

14. The marking system of claim 6, wherein the tag further comprises an indication located on the top portion of the tag.
